(19) United States
(12) Patent Application Publication
(10) Pub. No.: US 2014/0141382 A1
(43) Pub. Date: May 22, 2014

(54) OXYGEN INJECTOR FOR FURNACE AND REGENERATOR

(71) Applicant: Neil Simpson, By Eyemouth (GB)

(72) Inventor: Neil Simpson, By Eyemouth (GB)

(21) Appl. No.: 13/680,215

(22) Filed: Nov. 19, 2012

(51) Int. Cl. C03B 5/235; C03B 5/237

(52) U.S. Cl. CPC C03B 5/2353; C03B 5/237
USPC 432/30; 431/9; 432/219

(57) ABSTRACT

A method and apparatus for introducing oxygen enriched air into a furnace includes injecting oxygen to a combustion chamber of the furnace; and entraining air into the oxygen during the injecting. If the furnace is a cross-fired regenerative furnace, the method and apparatus for introducing oxygen enriched air can be mounted to at least one regenerator for the furnace.

### BACKGROUND

The present embodiments relate to apparatus and methods for injecting oxygen into a furnace.

Regenerative glass melting furnaces use regenerators—high temperature heat exchangers—which are essentially large assemblies of bricks and/or high temperature refractories. The regenerators can become blocked after many years of use or from perhaps structural failure of the refractory, which thus starves the furnace of air that the regenerator is providing.

In order to overcome the blockage of the regenerators, it is known to install by-pass flues for the blocked portion of the regenerators. Unfortunately, such flues result in lower air pre-heat temperatures, which is less efficient and results in increased gas use and accordingly, more air is needed for the furnace, which defeats the purpose of the by-pass flue.

It is also been known to enrich the furnace with oxygen either upstream, as a single injection point, or downstream, with a plurality of injection points through reversal valves. However, such an application is limited in the percentage of oxygen that can be used. Such oxygen still has to pass through the blockage in the regenerator and therefore, the problem is not cured.

Lancing has been found to be a more efficient method to provide oxygen to the furnace. However, when using large cross-fired furnaces, the installation for the lances can be quite significant, requiring construction of the furnace to accommodate the lances. Such construction may provide undesirable furnace conditions, wherein unwanted foam generation occurs in the glass melt.

Finally, there may be limits on the amount of compressed oxygen available at the site of the furnace.

### BRIEF DESCRIPTION OF THE DRAWINGS

For a more complete understanding of the present inventive embodiments, reference may be had to the following description of the embodiments taken in conjunction with the drawing figures, of which:

FIG. 1 shows a top plan view of a known sidewall regenerative furnace firing without oxygen injection;

FIG. 2 shows a cross-sectional side view of an oxygen injector embodiment of the present invention for use with a furnace;

FIG. 3 shows an end view in cross-section of the regenerative furnace taken along line 3-3 in FIG. 1 with positions for installation of the oxygen injector apparatus of FIG. 2;

FIGS. 4-7 show top plan views of the regenerative furnace having one or a plurality of the oxygen injector embodiments mounted for use with a respective one of the regenerative furnace;

FIG. 8 shows a cross-sectional side view of the oxygen injector embodiment of FIG. 1 for being mounted to a wall of a furnace regenerator;

FIGS. 9-12 show cross-sectional side views of alternative embodiments of the oxygen injector apparatus of the present invention; and

FIG. 13 shows a top plan view of a furnace having at least one oxygen injector apparatus embodiment for use therewith.

### DETAILED DESCRIPTION OF THE INVENTION

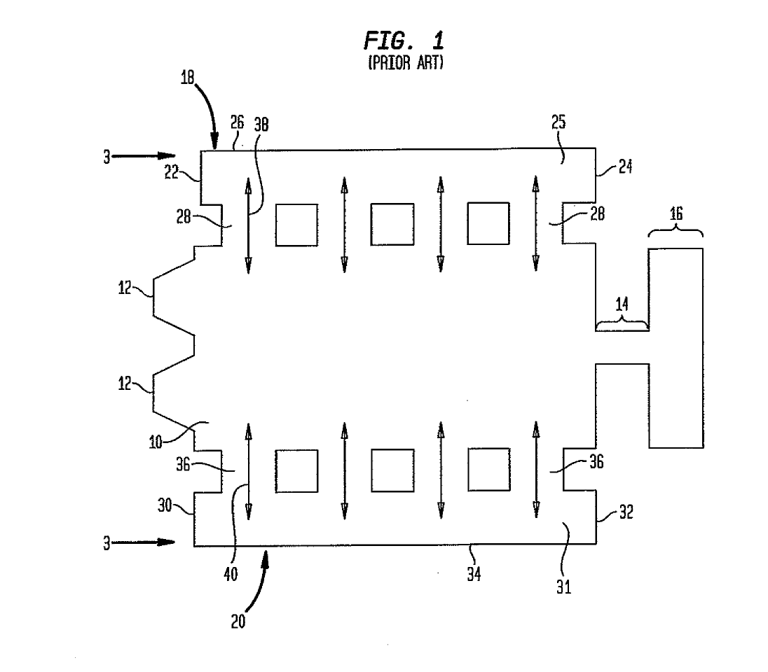

Referring to FIG. 1, a known furnace is shown generally at 10. The furnace can be used for heating applications to melt for example glass, steel, scrap metal or non-ferrous materials. By way of example only, the furnace 10 is a glass melting furnace to which the oxygen injector apparatus embodiment of the present invention can be mounted for operation.

The furnace includes at one end at least one and in some applications a pair of chargers 12 through which glass ingredients or other materials are introduced into the furnace for melting. The chargers 12 are located at an upstream end of the furnace 10, while a downstream end of the furnace includes a throat section 14 and a distribution section 16. The distribution section 16 may include a forehearth or other structure for distribution of the glass melt.

Mounted to each side of the furnace 10 is a regenerator 18,20, respectively. Therefore, in the combustion industry, the furnace 10 would be referred to as a cross-fired regenerative furnace. With respect to FIG. 1 and this description, the regenerator 18 will be referred to as the left-hand side regenerator, while the regenerator 20 will be referred to as the right-hand side regenerator. The regenerator 18 includes corresponding end walls 22,24, a top wall 23 or roof, and a side wall 26. A plurality of ports 28 of the regenerator 18 are in communication with the furnace 10.

The regenerator 20 also includes end walls 30,32, a top wall 31 or roof, and a side wall 34. A plurality of ports 36 of the regenerator 20 are in communication with the furnace 10. The sidewalls 26,34 are also known in the industry as the “target walls”.

A gaseous flow of air through the ports 28,36 is shown by arrows 38,40 respectively.

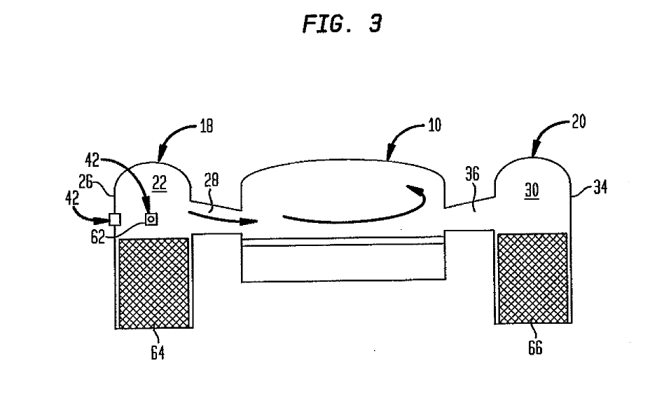

Although not shown in FIG. 1, but later shown and discussed in more detail with respect to FIG. 3, a plurality of heat recovery bricks, also known as checker bricks, are disposed in each one of the regenerators 18,20 such that each of the airflows 38,40 flows over and contacts a corresponding plurality of the heat recovery bricks. When firing, for example, from left to right in the furnace (from the regenerator 18 to the regenerator 20) combustion air is heated at the regenerator 18 and the heat recovered at the regenerator 20. This process is reversed when firing from right to left in the furnace 10.

In known cross-fired regenerative furnaces such as that shown generally at 10, any oxygen lancing would be directly into the furnace 10, but also be subjected to the disadvantages above with respect to such known furnaces. Operation of the regenerative furnace 10 as shown in FIG. 1 is therefore already known.

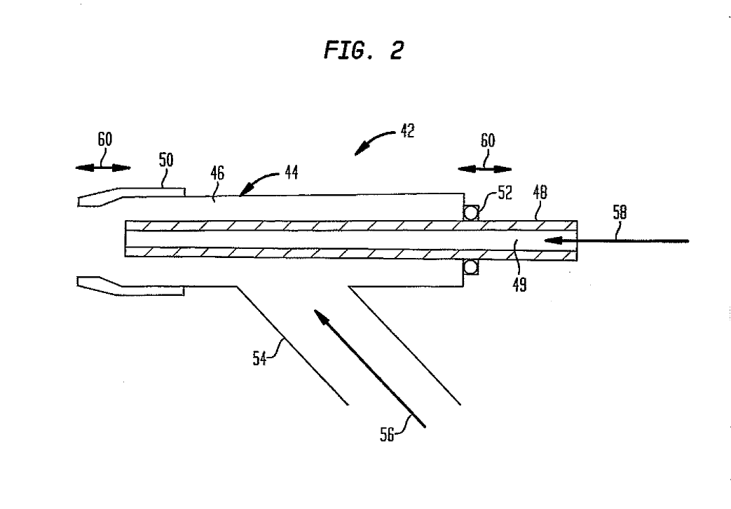

Referring to FIG. 2, an embodiment of an oxygen injector apparatus 42 of the present invention is shown for use with the known regenerative furnace 10. The injector 42 includes an injector body portion 44 having a space 46 or passageway therein in which to receive an oxygen lance 48 or pipe. The oxygen lance 48 includes an internal passageway 49. A distal end of the body portion 44 is provided with an injector nozzle 50. A proximal end of the body portion 44 is provided with a seal 52 or gasket. An inlet duct 54 is in fluid communication with the space 46 of the body portion 44 so that entrained air indicated by arrow 56 can be introduced into the space 46 to be mixed with an oxygen stream represented by the arrow 58 flowing through the passageway 49 to be introduced into the space 46 by the oxygen lance 48. That is, the injection of the oxygen stream 58 through the oxygen lance 48 entrains air 56 through the inlet duct 54 to be mixed in the space 46 with the oxygen stream.

The oxygen lance 48 is movably positionable and adjustable with respect to the nozzle 50 which will, in effect, control the flow of the entrained air 56 through the inlet duct 54 into the space 46. Arrows 60 represent movement of the oxygen lance 48 in the space 46. The lance 48 is movable along its longitudinal axis substantially parallel to a longitudinal axis of the body portion 44 extending along the space 46. All of the elements of the oxygen injector apparatus 42 are constructed of metal, except for the seal 52. In most applications, the entrained air 56 will be provided, for example injected, into the oxygen stream 58 before entering into the furnace 10 or the regenerators 18,20.

The oxygen injector apparatus 42 can be mounted to the regenerator in one or a plurality of positions as shown in FIG. 3. For example, the oxygen injector apparatus 42 can be mounted to the end wall 22 or the side/target wall 26 of the regenerator 18. Such location and mounting of the oxygen injector apparatus 42 can be through an existing peep site 62 of the regenerator 18. The oxygen injector apparatus 42 can also be mounted in a similar manner to the regenerator 20. The heat recovery bricks 64,66 or checker bricks discussed above with reference to FIG. 1, are shown in FIG. 3 as they would be disposed in respective ones of the regenerators 18,20. It should be understood that certain regenerators may have their end walls and/or side walls bored-out or originally manufactured to receive the oxygen injector apparatus 42, instead of mounting such apparatus in all of the peep sites 62. Operators of such furnaces will not want to plug all the peep sites with injector apparatus because it is important to be able to view an interior of the furnace 10 during combustion operations.

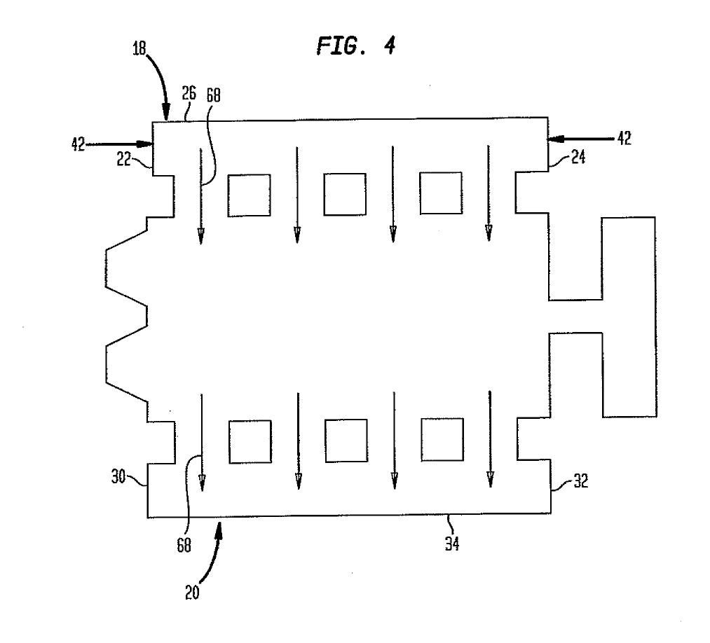

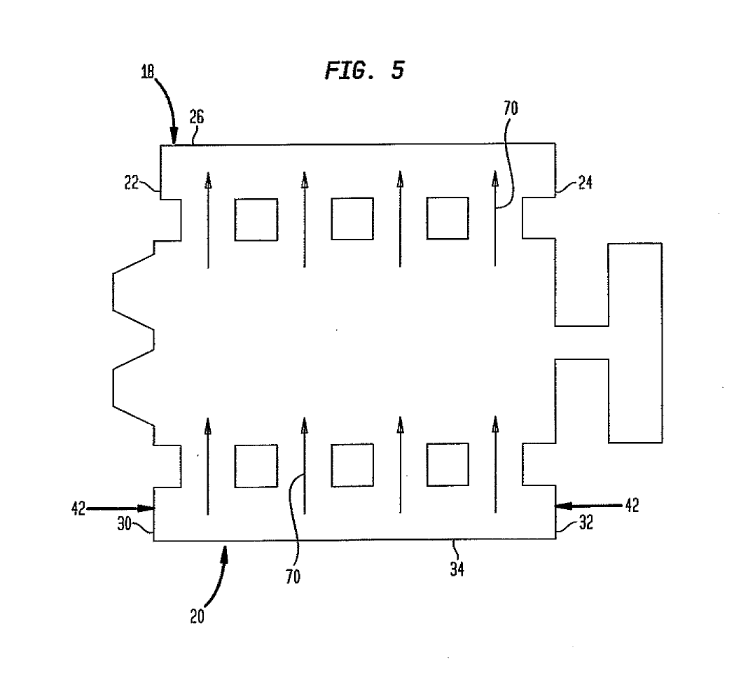

In FIGS. 4-6, the oxygen injector apparatus 42 is shown mounted at the end walls 22,24 and 30,32, including being mounted at the side walls 26,34. Referring to FIG. 4, arrows 68 show the gas flow being injected from the regenerator 18 that has the injector apparatus 42 mounted thereto. As will be discussed below, the oxygen injector apparatus 42 is mounted so that a discharge orifice discussed further herein is in communication with a space in the regenerator 18 (and 20) above the heat recovery bricks 64,66. As shown in FIG. 4, the gas flow 68 proceeds from the regenerator 18 into the furnace 10 to the regenerator 34 where it is exhausted or recycled. In FIG. 5, the oxygen injector apparatus 42 are mounted at the opposite regenerator 20 (the right-hand side regenerator) such that a gas flow 70 is from the regenerator 20 into the furnace 10 to the regenerator 18 where it is exhausted therefrom or recycled. With both embodiments of FIGS. 4 and 5, the oxygen injector apparatus 42 are mounted in the end walls of the respective regenerators 18,20.

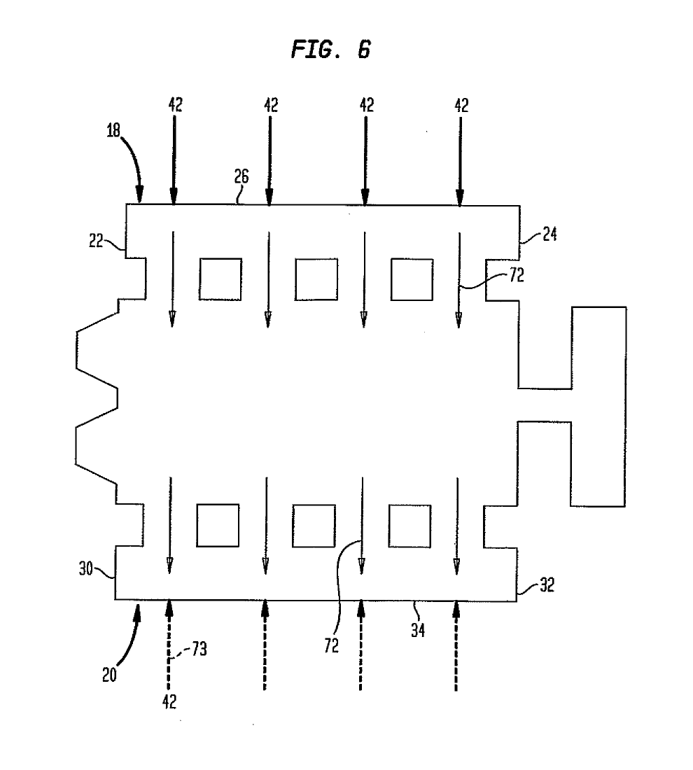

In FIG. 6, at least one, and for many applications a plurality of oxygen injector apparatus 42 are mounted in the side/target wall 26 of the regenerator 18. Accordingly, the gas flow represented by the arrow 72 shows the flow from the regenerator 18 into the furnace 10 and to the regenerator 20 where it is exhausted or recycled. It will be understood that the oxygen injector apparatus 42 could be mounted for use with the regenerator 20 as shown by the broken arrows 73 for said apparatus. In such manner of construction and application, the gas flow 73 would be reversed to flow from the regenerator 20 into the furnace 10 and then to the regenerator 18 where it would be exhausted or recycled.

Another embodiment has the oxygen injector apparatus 42 mounted at both side walls 26, 34 of the regenerators 18,20 respectively. However, for operation of same, only one regenerator will operate to provide the gas flow from the regenerator into the furnace while the other regenerator does not have its oxygen injector apparatus activated. After a select period of time, about 20-30 minutes, the active regenerator and oxygen injector(s) are deactivated, and the opposite regenerator and oxygen injector(s) are activated.

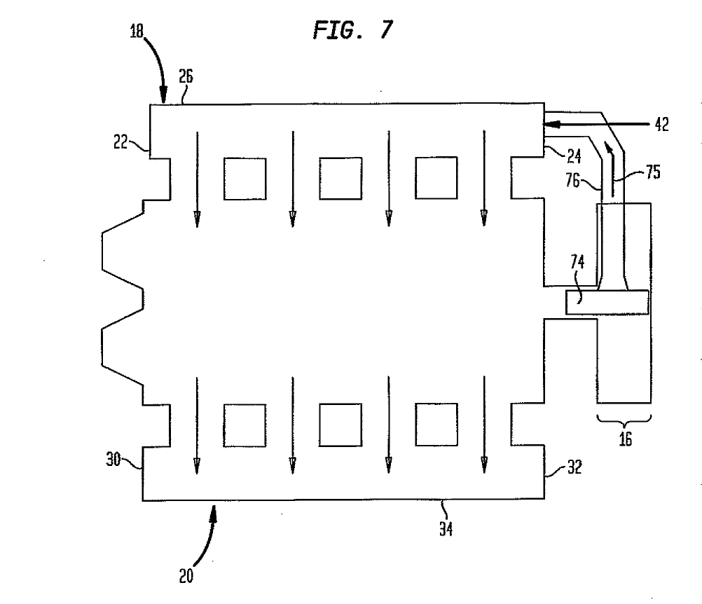

In FIG. 7, a still further embodiment of the regenerator is provided with the oxygen injector apparatus 42. The previous FIGS. show that the entrained air 56 into the inlet duct 54 originated externally from the furnace 10, the regenerators 18,20, the throat section 14 and the distribution section 16 of the furnace. Accordingly, the entrained air is ambient air and is much cooler than that which is provided in the regenerators 18,20. In the embodiment of FIG. 7, the inlet duct 54 (see FIG. 2) of the oxygen injection apparatus 42 is in communication with heated air from an area or region near a forehearth 74 or the distribution section 16. That is, the ambient air is drawn in from a region external to and proximate the furnace 10 and the regenerators 18,20 where the air is hot from exposure to the furnace and regenerators. The hot air is shown for example being delivered through a conduit 76 from a position near the forehearth to be provided to inlet duct 54 at the regenerator 18, as a heated air flow 75. It is understood that the arrangement of and coaction between the forehearth 74 and the conduit 76 could be such that the conduit is also in communication with the regenerator 20.

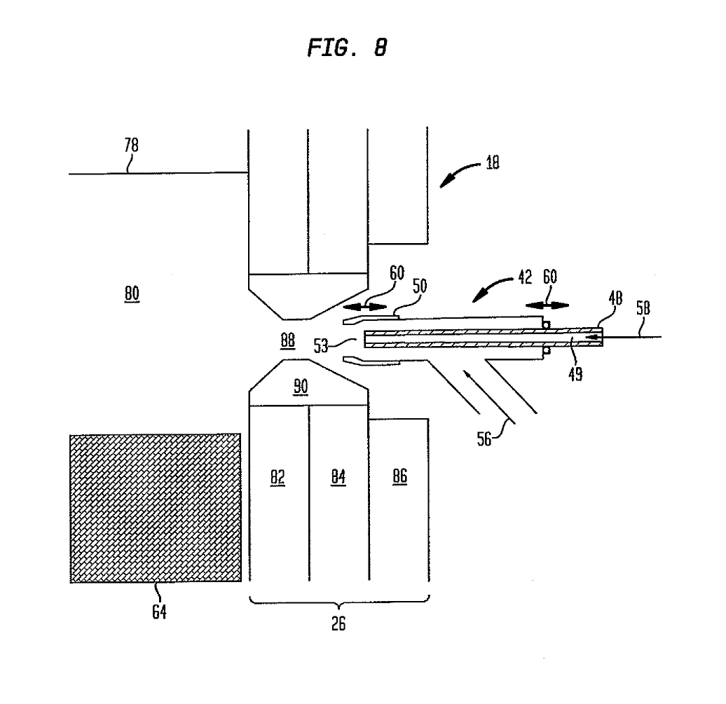

FIG. 8 shows in more detail how the regenerators 18,20 would have the oxygen injection apparatus 42 mounted thereto. The illustration of FIG. 8 could be with reference to the end walls 22,24 and 30,32 or the sidewalls 26,34. For purposes of explanation and by way of example only, the oxygen injection apparatus 42 is shown in FIG. 8 being mounted to the side wall 26 which, in conjunction with a roof 78 or crown of the regenerator, defines a space 80 or combustion chamber in the regenerator. The side wall 26 may be constructed of an internal wall portion 82 adjacent to the heated atmosphere of the combustion chamber 80. Adjacent to the wall 82 is an outer wall portion 84. Insulation 86 is mounted to the outer wall portion 84. The side wall 26 has a hole 88 extending therethrough the internal and outer wall portions 82,84 and the insulation 86 into which the oxygen injection apparatus 42 can be mounted. The hole 88 may be bored through the side wall 26 or alternatively, the peep site 62 of a regenerator 18,20 may be modified to receive the oxygen injection apparatus 42. A discharge orifice 53 of the apparatus 42 when mounted in the hole 88 is disposed above the heat recovery bricks 64. If the peep site 62 is used, the site is usually mounted in a block 90 in the sidewall 26.

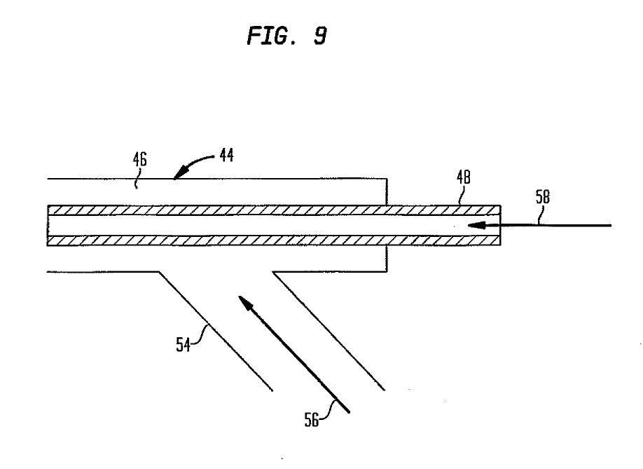

FIG. 9 shows another embodiment of the oxygen injection apparatus 42 having a more basic construction without the injector nozzle 50 and the seal 52.

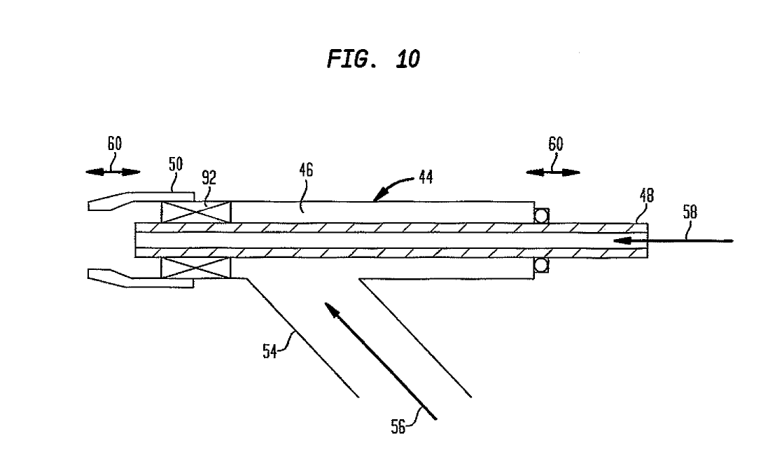

In FIG. 10, the oxygen injection apparatus 42 is essentially the same as that provided above in FIG. 2, with the addition of a swirler vane 92 or vortex element or member disposed in the space 46 to increase mixing of the entrained air 56 with the injected oxygen 58.

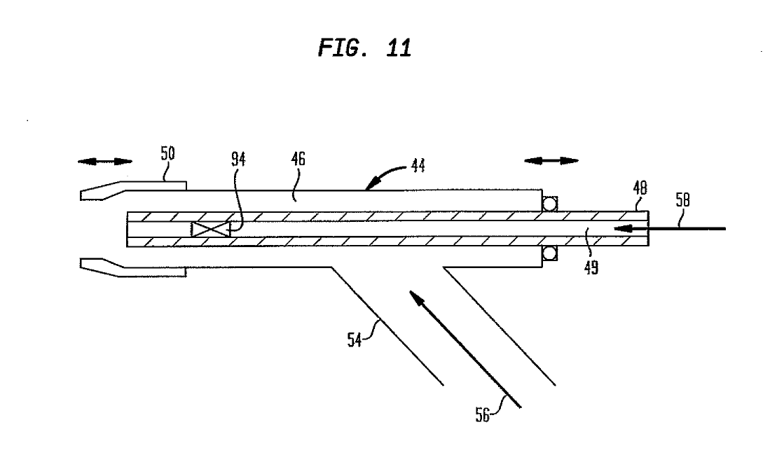

In FIG. 11, a swirler vane 94 or vortex element or member is disposed in the internal passageway 49 of the oxygen lance 48 to provide turbulence to the oxygen stream 58 to increase mixing of same with the entrained air flow 56.

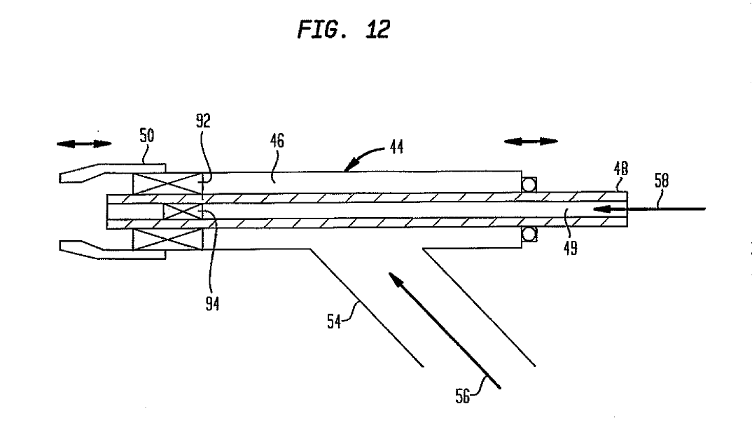

Referring to FIG. 12, the oxygen injection apparatus 42 includes both swirler vane elements 92,94 in a respective one of the space 46 and the passageway 49. Such construction provides the highest amount of turbulence to facilitate mixing the injected oxygen 48 with the entrained air flow 56.

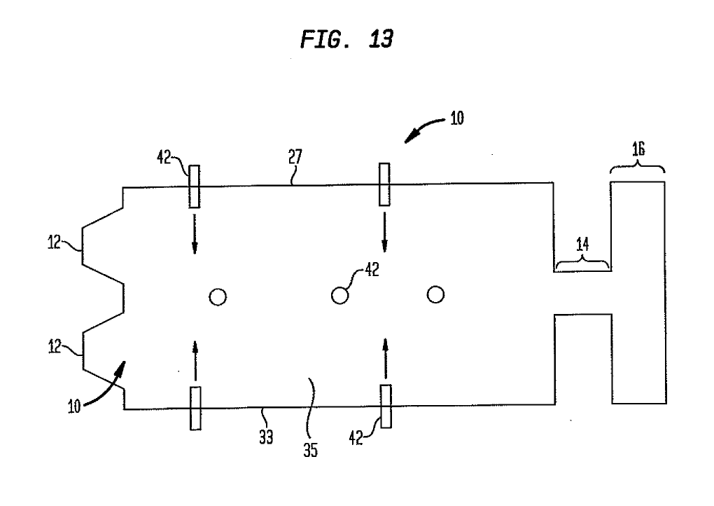

In FIG. 13, the furnace 10 is shown with the oxygen injector apparatus 42 mounted in side walls 27,33 of the furnace or alternatively, at least one oxygen injector apparatus 42 can be mounted in a roof 35 or crown of the furnace 10. It will be understood that any combination of the oxygen injector apparatus 42 can be mounted to the furnace through the existing side walls 27,33 or through the crown or through the roof 35, or even through existing peepholes (see FIG. 3) at the side walls. Similarly, the furnace 10 shown in FIG. 13 can be constructed with the features to direct the hot ambient air 75 to the oxygen injector apparatus 42 as shown in FIG. 7, and to provide the same beneficial result of providing hotter air to be entrained with the oxygen for being injected into the combustion chamber of the furnace.

The entrained air 56 can be provided to the oxygen stream 58 prior to the oxygen stream entering the regenerator 18,20 or the furnace 10.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A method of introducing oxygen enriched air into a regenerative furnace, comprising:
injecting oxygen to a top portion of a regenerator for the furnace; and
entraining air into the oxygen during the injecting.

2. The method of claim 1, wherein the injecting to the top portion is above heat recovery bricks in the regenerator.

3. The method of claim 2, wherein the injecting is through an end wall of the regenerator.

4. The method of claim 2, wherein the injecting is through a sidewall of the regenerator.

5. The method of claim 1, wherein the injecting is through a peep site hole in the regenerator.

6. The method of claim 1, further comprising directing hot ambient air from a region at an exterior of and proximate to the furnace into the entraining air for mixing with the oxygen and the air.

7. The method of claim 1, further comprising mixing the oxygen and the air.

8. The method of claim 1, further comprising creating turbulence in the entraining air for mixing with the oxygen.

9. The method of claim 1, further comprising creating turbulence in the injecting oxygen for mixing with the air.

10. The method of claim 1, further comprising adjusting a flow rate of the injecting oxygen for controlling a flow rate of the entraining air to be responsive to a flow rate of the injecting oxygen.

11. A method of introducing oxygen enriched air into a furnace, comprising:
injecting oxygen to a combustion chamber of the furnace; and
entraining air into the oxygen during the injecting and prior to the oxygen entering the combustion chamber.

12. The method of claim 11, further comprising directing hot ambient air from a region at an exterior of and proximate to the furnace into the entraining air for mixing with the oxygen.

13. The method of claim 11, further comprising creating turbulence in the entraining air for mixing with the oxygen.

14. The method of claim 11, further comprising creating turbulence in the injecting oxygen for mixing with the air.

15. A fluid injection apparatus for a furnace, comprising:
a housing having a space therein and a discharge orifice in communication with the space and a combustion chamber of the furnace;
a lance for oxygen disposed in the space and in communication with the discharge orifice; and
an inlet duct for air in communication with the space external to the lance.

16. The injection apparatus of claim 15, further comprising a nozzle mounted to the housing at the discharge orifice.

17. The injection apparatus of claim 15, wherein the lance is adjustably moveable within the space to control a flow of the oxygen and the air.

18. The injection apparatus of claim 15, wherein the housing is mounted to at least one of an end wall, a sidewall and a crown of the furnace and being in communication with the combustion chamber.

19. The injection apparatus of claim 15, further comprising a vortex member disposed in the space for creating turbulence of the air.

20. The injection apparatus of claim 19, wherein the vortex member comprises a swirler vane.

21. The injection apparatus of claim 15, further comprising a vortex member disposed at an interior of the oxygen lance for creating turbulence of the oxygen.

22. The injection apparatus of claim 21, wherein the vortex member comprises a swirler vane.

23. The injection apparatus of claim 15, further comprising a conduit having a first end in communication with the inlet duct, and a second end in communication with hot ambient air from a region at an exterior of and proximate to the furnace.

24. The injection apparatus of claim 15, wherein the housing is mounted to at least one of an end wall, a side wall and a roof of a regenerator for the furnace and being in communication with an interior of the regenerator.
